(19) United States
(12) Patent Application Publication
(10) Pub. No.: US 2026/0226258 A1
(43) Pub. Date: Aug. 6, 2026

(54) Sealed gas materials prepared from bio-based raw materials

(71) Applicant: Aalto University Foundation sr, Aalto (FI)

(72) Inventors: Laura Valentin, Aalto (FI); Satu Paavonsalo, Aalto (FI); Juha Lipponen, Aalto (FI); Jenni Roivas, Aalto (FI)

(21) Appl. No.: 19/154,793

(22) PCT Filed: Feb. 8, 2024
(86) PCT No.: PCT/FI2024/050049

§ 371 Date: Aug. 8, 2025

(30) Foreign Application Priority Data
Feb. 8, 2023 (FI) 20237027

(51) Int. Cl. C08L 1/02; C08J 9/00; C08J 9/30

(52) U.S. Cl. CPC C08L 1/02; C08J 9/0061; C08J 9/30; C08J 2203/06; C08J 2301/02; C08J 2401/26; C08L 2203/14; C08L 2205/025; C08L 2205/16

(57) ABSTRACT

The present invention relates to sealed gas materials composed at least mainly of bio-based raw materials. There are four 2024/165793 main types of materials under the invention: 1) sealed gas bubble sheet, 2) sealed gas pillows, 3) sealed gas foam sheets, and 4) sealed gas foam 3D objects. The materials can be used for protection, insulation, and/or construction. Typically, the materials are prepared by mixing one or more cellulose-based raw materials into an aqueous solution or dispersion from which a structure is formed, and inserting gas into the solution or dispersion, to form the structures with gas sealed within the material.

### FIELD OF THE INVENTION

The present invention relates to sealed gas materials composed at least mainly of bio-based raw materials.

Due to the sealed air embedded in the materials, they could be used, for example, as protective materials, insulation materials, and/or construction materials. Since the invention has similar features to plastic materials, the new materials could be used as a more sustainable option to replace plastic materials that are used for protection (e.g. protective plastic packaging materials), insulation (materials resembling styrofoam), and/or construction (e.g. cellular plastic).

The invention could be used as a protective packaging material for cushioning fragile items to help reduce the risk of damage during transportation and/or storing. Since the invention has similar features to conventional plastic bubble wrap, the invention could be used as a more sustainable option to replace plastic bubble wrap sheets and bubble wrap bags/mailers. Therefore, the invention could be used in the same market segments where plastic bubble wrap is used: 1) Manufacturing and warehousing (including electronics & electricals, automotive & allied industries, pharmaceutical, cosmetics & personal care, food & beverages etc.), 2) E-commerce, and 3) logistics and transportation.

Since the invention contains air/gas in it, it is also a great insulator and could be used in 4) construction. For example as insulation in construction (e.g. to replace cellular plastic materials used in construction).

Further, particularly a waterproof version of the fiber-based stock material could be used for textile coating, thus making the material useful in 5) Fashion and Textile

### BACKGROUND OF THE INVENTION

The alarmingly increasing rate of plastic production and the resulting plastic pollution are global concerns, as the plastic life cycle has several negative impacts on people and the environment. Plastic production relies on the use of non-renewable fossil fuels as the primary feedstocks and creates greenhouse gas emissions that contribute to climate change. In addition, the life cycle of plastics is mostly linear, with 79% of plastics ending up in landfills and the environment, 12% incinerated, and only 9% recycled. Because plastic does not naturally break down in the environment, the majority of plastic has continued to accumulate in soil and waterways for decades, causing significant harm and health risks across ecosystems through animal entanglement, plastic ingestion, and leaking of toxic substances into the environment.

There is a growing and urgent need for sustainable alternatives for plastic materials to help combat plastic pollution while addressing the growing demand for protective packaging materials and construction materials. Because of the plastic-related issues mentioned above, plastic-based materials (e.g. plastic packaging materials, styrofoam, cellular plastic) are not sustainable materials. The so-called “biodegradable bubble wraps” and “oxo-degradable bubble wraps” (e.g. by BioGone, UKPackaging and Kingfisher Packaging) are combinations of plant-based and petrochemical plastic feedstocks and often include harmful additives and/or toxins, and are thus not a sustainable replacement for conventional plastic bubble wrap. There are also wrappable materials made from paper (e.g. Paper bubble wrap, GreenWrap, and Flexi-Hex) and cardboard (e.g. Corrugated bubble), but these materials do not resemble plastic bubble wrap (i.e. do not trap air within bubbles) and are not available in various colors. There are also mushroom packagings made from mycelium and biodegradable packing peanuts made from starch, but these do not resemble bubble wraps (i.e. are not wrappable sheets nor trap air within bubbles) and are not available in various colors.

Therefore, there are no currently available protective packaging materials nor construction/insulation materials providing sustainable replacements for their plastic alternatives while being all of the following: plastic-free, non-toxic, fiber-based, biodegradable, wrappable, customizable in size/shape/color, and physically and visually similar to plastic materials, such as bubble wrap.

### SUMMARY OF THE INVENTION

The invention relates includes sealed gas materials that are at least to a main part composed of bio-based materials. There are four main types of materials under the invention: 1) sealed gas bubble sheet, 2) sealed gas pillows, 3) sealed gas foam sheets, and 4) sealed gas foam 3D objects. The materials can be used for protection, insulation, and/or construction. Thus, the materials can be used, for example, to protect items from breakage due to external pressure or hit or the movements and collisions of items, or to protect items which need insulation to keep the item preserved, or as coatings or as fillers. As one example, the materials can be used to replace conventional bubble wrap materials.

The invention's sealed gas materials are composed mainly of cellulose-based materials, preferably monomaterials, but may also contain other materials as plastizers and/or other materials to modify operation parameters for desired bubble formation.

The properties of the sealed gas materials, such as bubble size, distribution, color, haptic properties can be adjusted with operation parameters such as material ratio and concentration, viscosity of solution/dispersion, surface active materials, baking/drying temperature etc. to mention a few.

As the sealed gas material is bio-based, 100% biodegradable, compostable, and non-toxic, the innovation provides a sustainable solution for replacing plastic bubble wrap that is often discarded after only one use, thus enhancing the shift from plastics to sustainable packing materials.

As the materials are composed mainly of bio-based raw materials, the innovation provides a sustainable solution for replacing plastic-based materials such as plastic packaging materials that are often discarded after only one use, thus enhancing the shift from plastics to sustainable materials.

### DETAILED DESCRIPTION OF THE INVENTION

The invention relates to sealed gas structures, with gas-filled cavities in the material forming e.g. gas-filled pockets, the structures preferably being in the form of sheets or pillows or other 3D objects, and being composed at least mainly of bio-based raw materials.

Examples of cellulose-based materials that can be used in the structures of the invention are nanofibrillated cellulose (NFC), microfibrillated cellulose (MFC), cellulose nanocrystals (CNC), microcrystalline cellulose (MCC, which can also be fibrillated), and cellulose nanofibres (CNF), as well as cellulose derivatives including carboxymethyl cellulose (CMC), methyl cellulose (MC), hydroxypropyl cellulose (HPC), and sodium carboxymethyl cellulose (NaCMC). Typically, they are used in aqueous solutions or dispersions, preferably in concentrations of 30-1000 g/l.

The additives that may be used include bubble-and foam-sustaining chemicals (e.g. glycerol C₃H₈O₃), sorbitol, rheology modifiers, in various concentrations, typically in a concentration of less than 100 g/l, preferably 10-100 g/l, more preferably 30-80 g/l. For example for CMC, it can be used in a wide range of concentrations, such as 0.1-20 % by weight, preferably about 3% by weight, and for glycerol, it is preferably used in a concentration of about 50 g/l to provide an optimal product. Also dyes or pigments may be added.

The gas can be air, nitrogen (N₂), oxygen (O₂), carbon dioxide (CO₂), nitrous oxide (N₂O) or any mixture of these. Preferably air is used due to its availability.

Typically, the materials are prepared by mixing one or more cellulose-based raw materials with suitable additives into an aqueous solution or dispersion from which a structure, such as a sheet, is formed, and inserting gas or air into the aqueous solution or dispersion by adding/injecting, mixing, reacting or foaming methods to form the structures resembling bubbles within the cellulose-based material, for example, carboxy methyl cellulose and nanofibrillar cellulose, with gas trapped or sealed within the material to form gas-filled cavities. The viscosity of the solution is adjusted to withhold gaseous bubbles prior to the drying of the material, to form solid bubbled film, sheet or other similar structure to form bubble wrap. The viscosity can be adjusted in the formed structure, optionally after a partial solidification, e.g. by varying the gas content and pressure, material concentration, surface tension, and operation temperatures such as drying/baking time.

The structures in the form of sheets are typically prepared by distributing the prepared solution or dispersion into a desired thickness onto a surface, e.g. by pouring into a flat container. The thickness of the sheet may be, for example, 0.1-7 cm, preferably being 0.2-6 cm, more preferably 0.5-1 cm. 3D structures are typically prepared by moulding, and they may be larger than the sheets. Typically, to simplify their production, their width is limited to about 5 m. An example of a 3D structure would be a slightly flattened object having the dimensions 4×3×5 m, or a packaging peanut having the dimensions 3×2×1 cm.

Suitable techniques for use in the gas trapping steps of the preparation are mixing to form a foam, foam floatation, headbox air injection, and slot die curtain coating and roll coating. Also a flotation device can be utilized to prepare large amounts of the wet foam material. For the industrial scale, it is possible to provide several bubbles simultaneously.

Another alternative is trapping or sealing air between two or more films of the stock material, optionally being dry or partially dried films, i.e. the solution or dispersion formed of the cellulose-based material.

A third alternative is forming the gas in the material by a chemical reaction, resulting in carbon dioxide (CO₂) being formed. The reaction is typically selected from electrolytic reactions and from fermentation reactions, whereby a carbohydrate and yeast are added into the solution or dispersion before forming the gas.

Also cavitation or boiling can be used to create the gas in the material, or physical methods, such as nucleation, sparging, and ultrasonic or supersonic vibration.

This foaming or gas sealing is preferably followed by solidifying the structures, e.g. by allowing them to partly dry at room temperature, or by heating, suitably at a temperature of <350° C., preferably <100° C., particularly a temperature of 40-80 degrees Celsius, for example at 50° C., preferably for a time period of 5 seconds to 48 h, such as for 20 min 24 h, or 20 min-2 h, whereby a solid yet typically flexible form is obtained that contains intact gas bubbles.

The foaming/gas sealing and solidification steps may optionally be repeated up to 15 times, preferably 2-8 times, or particularly 4-6 times, until the material is filled with bubbles of desired size and distribution. Further, the structures with trapped or sealed gas may be baked or dried, typically by air drying or by thermal drying, preferably at a temperature extending from room temperature to an elevated temperature of <100° C., more preferably at 40-80 degrees Celsius, to obtain a solid structure. This final baking or drying can take place for a longer period of time, such as up to 48 h, for example overnight.

The formation of intact, solid film, sheet or other similar form requires a drying process where solvents are removed from the film, sheet or other similar form with gaseous bubbles by heating, blowing or under negative pressure for a certain period of time.

Conditions for solidification can be adjusted in terms of vapor saturation and drying time to obtain desired bubble sheet structure such as bubble size and their distribution and properties such as mechanical, flexibility and haptic properties.

The sealed gas can form structures resembling bubbles, whereby the term “bubble” can be used to describe said structure. Likewise, “bubble wrap” can be used to define the complete material.

In a preferred embodiment the bubbles formed will stand close together and function as mechanical protection. A film, sheet or other similar form containing gas bubbles results in bubble wraps of different forms to be applied in, for instance, packaging application to protect items Thus, in the method for preparing a plastic-free, non-toxic, fiber-based, biodegradable bubble wrap, gas or air is inserted into an aqueous solution or dispersion of a cellulose-based material by injecting or foaming methods to form bubbles within the material, and the viscosity of the solution or dispersion is adjusted to withhold gaseous bubbles prior to the drying of the material by heating, blowing or under negative pressure, to form a solid bubbled film, sheet or other similar form.

In an embodiment, this method will provide a film, which in the areas without bubbles can have a thickness of 0.5-1 cm.

The film has the advantage of resembling plastic and being color-customizable. Further, the bubble wraps of the invention can be used as sustainable packing materials that are environmentally and ethically better options compared to the main competing product plastic bubble wrap. Using the present sustainable packing material provides sustainable actions that help ensuring the future of our planet.

### DESCRIPTION OF EMBODIMENTS OF THE INVENTION

In an embodiment, one or more solutions or dispersions of two or more different cellulose-based raw materials are mixed together to form the aqueous solution or dispersion from which the bubble wrap is formed.

Examples of cellulose-based materials are nanofibrillated cellulose (NFC), microfibrillated cellulose (MFC), cellulose nanocrystals (CNC), microcrystalline cellulose (MCC, which can also be fibrillated), and carboxymethyl cellulose (CMC). Typically, they are used in aqueous solutions or dispersions, preferably in concentrations of 30-1000 g/l.

Additives may be used, such as bubble-and foam-sustaining chemicals (e.g. glycerol C₃H₈O₃), sorbitol, rheology modifiers, in various concentrations, typically in a concentration of less than 100 g/l, preferably 10-100 g/l, more preferably 30-80 g/l. For example for glycerol, it can be used in a concentration of about 50 g/l to provide an optimal product. Also dyes or pigments may be added.

These materials are all bio-based, 100% biodegradable, compostable, and non-toxic. A prototype mixture consists of two different solutions prepared separately and then mixed together or simultaneously in a preferred ratio between 9:1-1:9, more preferred 3:7 7:3, the most preferred 1:1.

In a preferred embodiment, two different solutions or dispersions are prepared separately and then mixed together to form the aqueous solution or dispersion, preferably with the first solution being carboxymethyl cellulose (CMC) dissolved in water or an aqueous solution and the second solution or dispersion being nanofibrillar cellulose (NFC) and glycerol dissolved or dispersed in water or an aqueous solution.

The mixing of the cellulose-based material(s) into water, or to combine them, can be carried out by hand, e.g. by using a spoon, or by using a hand blender or magnetic stirrer, typically for 1-24 hours.

In an embodiment, the structure is prepared from the aqueous mixture of the cellulose-based material(s) by distributing the prepared solution or dispersion into a desired thickness onto a surface, e.g. by pouring into a flat container, to prepare a film-like sheet. The thickness of the sheet may be, for example, of 0,5-1 cm.

To achieve the bubbles in the structure, air is preferably blown into the solution or dispersion, advantageously into a depth close to the surface of the film. This may be carried out, e.g. by using a syringe or other similar equipment with a needle or other pointed hollow tip.

The film may be baked or partially dried, typically by thermal drying, suitably at 40-80 degrees Celsius, for example at 50° C. This baking or partial drying may take place for 20 min-2 h, for example for 1 h. After the partial drying, more bubbles may also be added into the structure.

In an embodiment, the drying and bubble formation steps are repeated 2-8 times, until the material is filled with bubbles of desired size and distribution.

Finally, the bubble structure may be baked or dried, again typically by thermal drying, preferably at 40-80 degrees Celsius, to obtain a solid structure, which may be detached from the container. This final baking or drying can take place for a longer period of time, such as up to 48 h, for example overnight.

### EXAMPLE EMBODIMENTS

### 1. Sealed Gas Sheet Materials

Different amounts of bubble-and foam-sustaining chemicals (e.g. glycerol C₃H₈O₃), sorbitol, rheology modifiers (e.g. carboxymethyl cellulose, CMC), solution solids content have been studied. In addition, various cellulose derivatives have been tested, including nanofibrillated cellulose (NFC), microfibrillated cellulose (MFC), cellulose nanocrystals (CNC), microcrystalline cellulose (MCC) (which can also be fibrillated). Different options have also been explored for making the material moisture-repellent.

As an example of embodiments of the invention
1) For the first solution, dissolve CMC (Carboxymethyl cellulose) in water/aqueous solution, for example, 3 grams of the powder to 97 ml of water. In small quantities it can be mixed with a hand blender or magnetic stirrer or other mixing methods.
2) For the second solution, dissolve/disperse NFC (Nanofibrillar cellulose), Glycerol in water/aqueous solution. Material ratio can be but not limited to, for example,
100 grams of NFC
10 ml Glycerol
200 ml water
   1. Measure the NFC and water into a beaker and mix using a spoon or other mixing method.
   2. Place the magnet into the beaker and move beaker onto magnetic stirrer. The magnet should be rotating evenly. Mixing should be continued from at least an hour up to 24 until homogeneous solution/dispersion.
   3. Add the glycerol to the mixture, mix for some time, for example, an additional hour.

### Making of Bubble Wraps:

1. Prepare both solutions and mix, for example, 1:1 using, for example, a hand blender.
2. Add dyes/pigments. Note, this is optional.
3. Pour into a flat container to have a film with thickness, for example, of 0,5-1 cm.
4. Blow air/gas bubbles into the solution using, for example, a Pasteur pipette
5. Bake/dry the film for a period of time of time intervals and at certain or variable temperatures, for example, 1 h at 50 degrees of Celsius.
6. Blow more bubbles into the drying film, in a laboratory scale for example, using a pipette.
7. Repeat steps 5 and 6 until the material is filled with bubbles of desired size and distribution.
8. Form a final dried up bubble film by baking/drying, for example, overnight at 50 degrees of Celsius.

Other possible mixtures include adding material to make the bubble wrap water-repellent, it will also be tested if other ratios could work. Colors, bubble sizes, shapes and distribution can adjusted by various parameters such as air/gas content and pressure, material concentration, surface tension, solution/dispersion viscosity and operation temperatures such as drying/baking time.

### Bubble Generation and Drying Techniques

The emphasis has been on studying and testing existing, continuous industrial bubble and foam generation techniques derived from the paper industry and determining the most optimal technology for scale-up testing. These technologies include (but is not limited to) foam floatation, headbox air injection, and slot die curtain coating and roll coating, as well as traditional plastic bubble wrap production technologies (in which sheets of plastic are pressed together in a nip of rolls with bubble-sized cavities in the cover) and foam forming technology which utilizes air bubble-containing aqueous foam as a carrier fluid for the raw materials.

Air inlet may be continuous or pulsed air feed to optimize the bubble formation into the viscous stock material.

### Example 1

### Sealed Gas Sheet Material (Bubble Wrap)

The invention material consists of a mixture of two solutions: 1) 3% carboxymethyl cellulose in water and 2) nanofibrillar cellulose (NFC) and glycerol mixture in water. These solutions are prepared separately and then mixed together in a ratio of 1:1.

1) Preparation of 0,1% to 25% CMC (w/v) in water: most optimal is in between 1% to 6%

### Materials:

3 g of CMC with high viscosity (powder)

97 mL of tap water
1. Weigh the CMC in a beaker and add water to make the 3% solution
2. Mix the solution at room temperature using a hand blender or magnetic stirring until the CMC has dissolved.

2) Preparation of the NFC-glycerol mixture in water:

### Materials:

100 g NFC

10 mL glycerol

200 mL tap water
1. Weigh the NFC in a beaker, add water and mix using a spoon.
2. Place a magnet rod into the mixture and move the beaker onto a magnetic stirrer. Mix at room temperature for at least 1 h and up to 24 h with the magnet rotating in a controlled manner.
3. Add glycerol and continue mixing with magnetic stirring for one hour.

### Preparation of the Bubble Wraps

### Materials:

3% CMC in water

NFC-glycerol mixture in water

(Optional: dyes/pigments)

Hand blender

Flat and smooth bottomed, rigid container

Spoon

Pasteur pipette with a flexible and thin nozzle/tip
1. Prepare the two solutions as described above.
2. Mix the solutions on a ratio of 1:1 at room temperature using a hand blender.
   1. Optional: Add dyes/pigments.
3. Pour the solution onto a flat and smooth-bottomed container and spread into a 0.5 mm-1 cm thick layer as evenly as possible using a spoon.
   1. Note: The container should be non-flexible and able to withstand heating up to at least 50° C.
4. Inject air bubbles into the solution using a Pasteur pipette with a flexible and thin nozzle/tip.
   1. Note: The air bubbles should be formed near the surface of the solution layer and not into the bottom to ensure that the bubbles remain intact.
   2. Note: The amount, size and frequency of the bubbles can vary. Bubbles can remain intact also when they are right next to other bubbles.
5. Bake/dry for 1 h at 50° C.
   1. Note: some air bubbles can burst during the baking.
6. Repeat steps 4 and 5 until the desired air bubble coverage is achieved.
7. Bake/dry at 50° C. overnight or until the material has solidified.
8. Carefully detach the bubble wrap sheet from the container by hand.

### Outcomes

The bubble wraps are flexible, can be wrapped around different items and provide cushioning due to the air bubbles embedded within the sheets. The bubble wraps can be translucent or colored with a variety of colors, and the sheets can be made into different shapes and sizes depending on the container. The air bubbles can vary in size and/or frequency within the sheets.

### 2. Sealed Gas Pillows/Pre Dried Sheets

Products in the form of sealed gas pillows can also be prepared by trapping or sealing air between two thin and dried films of the stock material. Thus the material solution/dispersion can be prepared as described above.

### Preparation

The recipe and preparation of these sheets is the same or similar to the sealed gas sheet material. But without adding the bubbles to the wet stock. Instead once the sheets are dried they are are pressed together, using water, cmc or the original wet stock. Once the glued together sheets also dry they are inflated, trapping or selaing gas in between them. The resulting bubbles/gas pockets size form really small (like in the foam sheets) and can get as big as wanted (several meters even).

### Example 2

### Sealed Gas Pillows

The invention material consists of a mixture of two solutions: 1) 3% carboxymethyl cellulose in water and 2) nanofibrillar cellulose (NFC) and glycerol mixture in water. These solutions are prepared separately and then mixed together in a ratio of 1:1.

1) Preparation of 0,1% to 25% CMC (w/v) in water: most optimal is in between 1% to 6%

### Materials:

3 g of CMC with high viscosity (powder)

97 mL of tap water
1. Weigh the CMC in a beaker and add water to make the 3% solution
2. Mix the solution at room temperature using a hand blender or magnetic stirring until the CMC has dissolved.

2) Preparation of the NFC-glycerol mixture in water:

### Materials:

100 g NFC

10 mL glycerol

200 mL tap water
1. Weigh the NFC in a beaker, add water and mix using a spoon.
2. Place a magnet rod into the mixture and move the beaker onto a magnetic stirrer. Mix at room temperature for at least 1 h and up to 24 h with the magnet rotating in a controlled manner.
3. Add glycerol and continue mixing with magnetic stirring for one hour.

### 3. Sealed Gas Foam Sheets

The sealed gas foam can be prepared using almost the same recipe as for the sealed gas (“bubble”) sheet. The difference here is that water and soap are added to the solution/dispersion of cellulose-based material in the recipe to create foamy material with lots of bubbles of various sizes. The example material of this embodiment consists of: 1) 3% carboxymethyl cellulose in water, 2) nanofibrillar cellulose (NFC) and glycerol mixture in water, as well as soap, 3) water, and 4) soap. Solutions 1 and 2 are prepared separately and then mixed together in a ratio of 1:1. This solution is then further diluted with water in a ratio of 1:1, and 0.5 g of soap is added per 100 ml of the diluted solution.

### Preparation of the Foam Sheets

### Materials:

3% CMC in water

NFC-glycerol mixture in water

Soap

(Optional: dyes/pigments)

Hand blender

Flat and smooth bottomed, rigid container

Spoon

1) Preparation of 0,1% to 25% CMC (w/v) in water: most optimal is in between 1% to 6%

### Materials:

3 g of CMC with high viscosity (powder)

97 mL of tap water
1. Weigh the CMC in a beaker and add water to make the 3% solution
2. Mix the solution at room temperature using a hand blender or magnetic stirring until the CMC has dissolved.

2) Preparation of the NFC-glycerol mixture in water:

### Materials:

100 g NFC

10 mL glycerol

200 mL tap water
1. Weigh the NFC in a beaker, add water and mix using a spoon.
2. Place a magnet rod into the mixture and move the beaker onto a magnetic stirrer. Mix at room temperature for at least 1 h and up to 24 h with the magnet rotating in a controlled manner.
3. Add glycerol and continue mixing with magnetic stirring for one hour.

Prepare the two solutions as described above.
1. Mix the solutions on a ratio of 1:1 at room temperature using a hand blender.
   a. Optional: Add dyes/pigments.
2. Dilute the solution in water on a ratio of 1:1 at room temperature using a hand blender.
3. Add 0.5 g of soap per 100 ml of the diluted solution.
4. Mix using a hand blender (optionally, use a flotation device).
5. Pour the solution (having a viscosity of around 1750 mPa·s) onto a flat and smooth-bottomed container and spread into a 0.5 mm-1 cm thick layer as evenly as possible using a spoon.
   a. Note: The container should be non-flexible and able to withstand heating up to at least 50° C.
6. Bake/dry at 50° C. for at least 6 h, or overnight, or until the material has solidified, in a device with air flow.
7. Carefully detach the foam sheet from the container by hand.

### Outcomes

The foam sheets are flexible, can be wrapped around different items and provide cushioning due to the gas bubbles embedded within the sheets. The material can be white/beige or colored with a variety of colors, and the sheets can be made into different shapes and sizes depending on the container. The air bubbles can vary in size and/or frequency within the sheets.

### 4. Sealed Gas Foam 3d Objects (aka. Packing Peanuts)

The material used for making three-dimensional objects from the foam material is based on the recipe described for the foam sheets. The main difference is that the foam material is used to make 3D objects instead of flat/planar sheets with minor gas contents. The 3D objects can be, for example, round objects that can be used as packaging peanuts.

The invention material consists of the same mixture as described for the foam sheets: 1) 3% carboxymethyl cellulose in water, 2) nanofibrillar cellulose (NFC) and glycerol mixture in water, as well as soap, 3) water, and 4) soap. Solutions 1 and 2 are prepared separately and then mixed together in a ratio of 1:1. This solution is then further diluted with water in a ratio of 1:1, and 0.5 g of soap is added per 100 ml of the diluted solution.

### Preparation of the Foam 3d Objects

### Materials:

3% CMC in water

NFC-glycerol mixture in water

Soap

(Optional: dyes/pigments)

Hand blender

Flat and smooth bottomed, rigid container

Spoon

1) Preparation of 0,1% to 25% CMC (w/v) in water: most optimal is in between 1% to 6%

### Materials:

3 g of CMC with high viscosity (powder)

97 mL of tap water
1. Weigh the CMC in a beaker and add water to make the 3% solution
2. Mix the solution at room temperature using a hand blender or magnetic stirring until the CMC has dissolved.

2) Preparation of the NFC-glycerol mixture in water:

### Materials:

100 g NFC

10 mL glycerol

200 mL tap water
1. Weigh the NFC in a beaker, add water and mix using a spoon.
2. Place a magnet rod into the mixture and move the beaker onto a magnetic stirrer. Mix at room temperature for at least 1 h and up to 24 h with the magnet rotating in a controlled manner.
3. Add glycerol and continue mixing with magnetic stirring for one hour.

Prepare the two solutions as described above.
1. Mix the solutions on a ratio of 1:1 at room temperature using a hand blender.
   a. Optional: Add dyes/pigments.
2. Dilute the solution in water on a ratio of 1:1 at room temperature using a hand blender.
3. Add 0.5 g of soap per 100 ml of the diluted solution.
4. Mix using a hand blender.
5. Pour the solution onto any kind of three-dimensional container/mold into the desired thickness.
   a. Note: The container should be able to withstand heating up to at least 50° C.
6. Bake/dry at 50° C. overnight or until the material has solidified.
7. Carefully detach the foam objects from the container/mold by hand.

### Outcomes

The foam 3D objects are flexible, soft, and provide cushioning due to the gas bubbles embedded within the sheets. The material can be white/beige or colored with a variety of colors, and the objects can be made into different shapes and sizes depending on the container/mold. The air bubbles can vary in size and/or frequency within the 3D objects.

### FIGURE CAPTIONS

FIG. 1. Competitive landscape to compare the invention's bubble wrap with the existing similar solutions in the market.

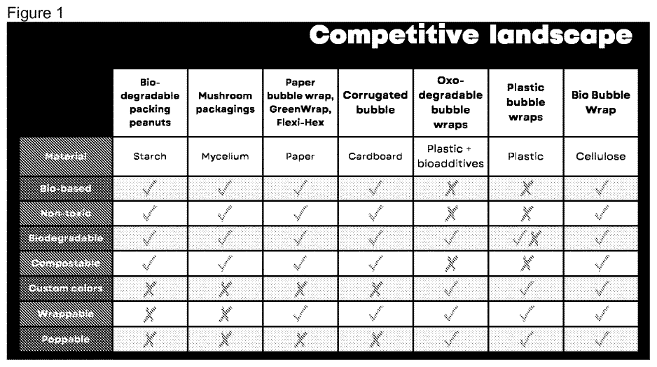

FIG. 2. Various samples of bubble wraps

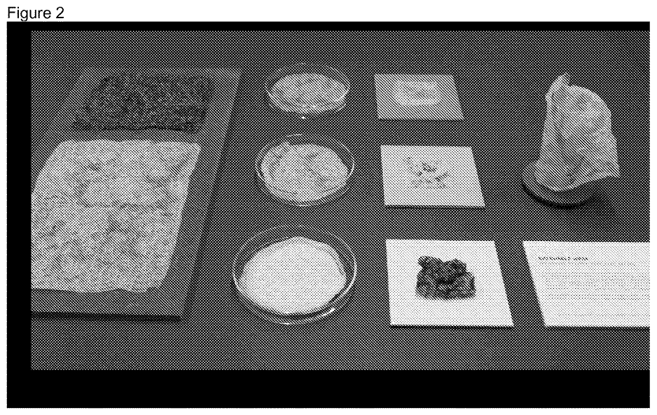

FIG. 3. Colored bubble wraps and an exemplary wrapping of the item with the invention's bubble wrap

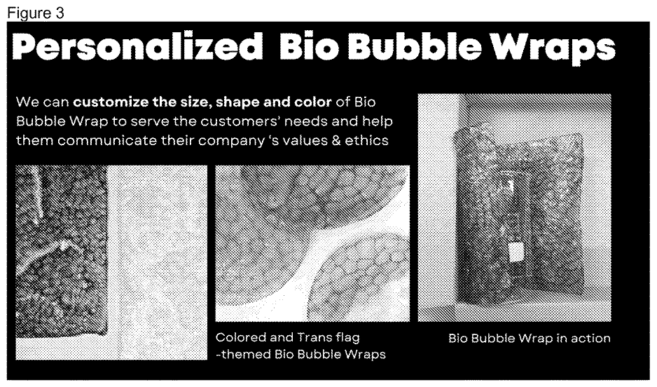

FIG. 4. An exemplary wrapping of the item with the invention's bubble wrap

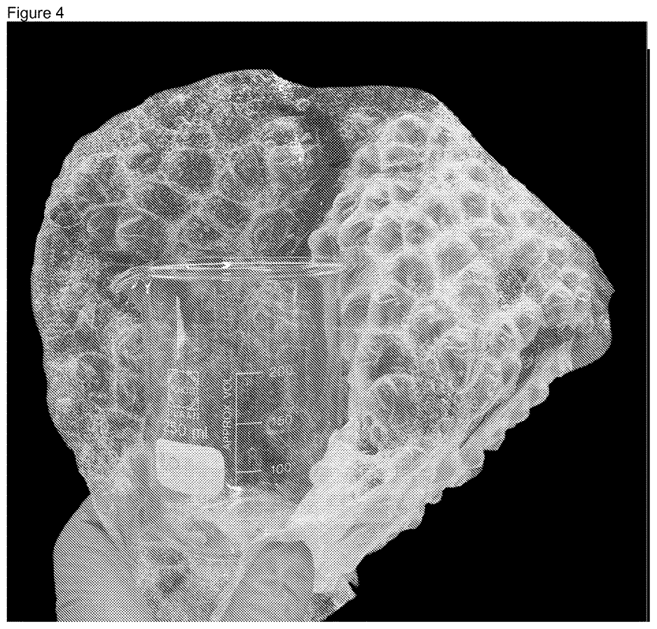

FIG. 5. An exemplary wrapping of the item with the invention's bubble wrap

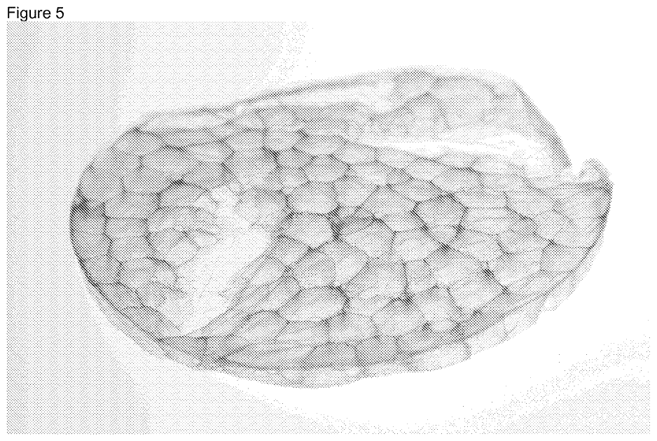

FIG. 6. An exemplary wrapping of the item with the invention's bubble wrap

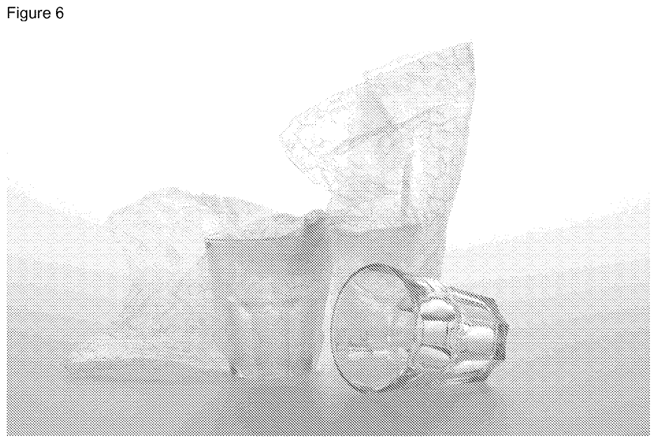

1-15. (canceled)

16. A bio-based sealed gas material, the bio-based sealed gas material being formed of one or more cellulose-based materials, optionally combined with one or more additives, and the bio-based sealed gas material being the form of a solid structure with gas sealed between its surfaces to form one or more gas-filled cavities in the bio-based sealed gas material.

17. The sealed gas material of claim 16, wherein the cellulose-based materials are selected from the group consisting of nanofibrillated cellulose (NFC), microfibrillated cellulose (MFC), cellulose nanocrystals (CNC), microcrystalline cellulose (MCC), cellulose nanofibres (CNF), carboxymethyl cellulose (CMC), methyl cellulose (MC), hydroxypropyl cellulose (HPC), and sodium carboxymethyl cellulose (NaCMC).

18. The sealed gas material of claim 16, wherein the sealed gas material further comprises bubble-and foam-sustaining chemicals, sorbitol, and/or rheology modifiers as additives.

19. The sealed gas material of claim 16, wherein the gas sealed within the seal gas material is air, nitrogen (N₂), oxygen (O₂), carbon dioxide (CO₂), nitrous oxide (N₂O) or any mixture of these.

20. The sealed gas material of claim 16, wherein the sealed gas material is in the form of a sealed gas bubble sheet, sealed gas pillow, seal gas foam sheet, or a three-dimensional sealed gas foam object.

21. A method for preparing a sealed gas material, the method comprising:
mixing one or more cellulose-based materials, optionally with one or more additives, into an aqueous solution or dispersion,
forming a structure from the aqueous solution or dispersion in one or more layers,
providing gas into the structure to a form a sealed gas material, and
drying the formed sealed gas material.

22. The method of claim 21, wherein one or more solutions or dispersions of two or more cellulose-based materials are prepared, wherein a first cellulose-based material comprises carboxymethyl cellulose (CMC) in a first aqueous solution, and wherein a second cellulose-based material comprises nanofibrillar cellulose (NFC) mixed with glycerol in a second aqueous solution.

23. The method of claim 22, wherein the first cellulose-based material and the second cellulose-based material are provided in a concentration of 30-1000 g/l in total.

24. The method of claim 22, wherein the first and second aqueous solutions are mixed in a ratio of 9:1-1:9.

25. The method of claim 24, wherein the first and second aqueous solutions are mixed in a ratio of 7:3-3:7.

26. The method of claim 21, wherein the viscosity of the aqueous solution or dispersion is adjusted in the formed structure, optionally after a partial solidification, to withhold gaseous bubbles prior to the drying step, by varying gas content and pressure, material concentration, surface tension, and/or drying temperature.

27. The method of claim 21, wherein the structure is formed as a sheet by distributing the prepared solution or dispersion onto a surface or into a 3D structure.

28. The method of claim 21, wherein the gas is provided into the structure by mixing to form a foam, injecting, by foam floatation, by headbox air injection, or by slot die curtain coating or roll coating, or by utilizing a flotation device, or alternatively the gas is provided into the material by a chemical reaction.

29. The method of claim 21, wherein the gas is provided into the material by trapping the gas between two or more films of the aqueous solution or dispersion.

30. The method of claim 21, wherein the formed sealed gas material is dried by air drying or by heating at room temperature or an elevated temperature for a time period of 5 seconds to 48 h.

31. The method of claim 21, wherein the providing gas and the drying steps are repeated 2-8 times, until the material is filled with gas bubbles of desired size and distribution.

32. The method of claim 21, wherein the cellulose-based materials are selected from the group consisting of nanofibrillated cellulose (NFC), microfibrillated cellulose (MFC), cellulose nanocrystals (CNC), microcrystalline cellulose (MCC), cellulose nanofibres (CNF), carboxymethyl cellulose (CMC), methyl cellulose (MC), hydroxypropyl cellulose (HPC), and sodium carboxymethyl cellulose (NaCMC).

33. The method of claim 21, wherein the mixing step further comprises mixing bubble-and foam-sustaining chemicals, sorbitol, and/or rheology modifiers as additives with the one or more cellulose-based materials.

34. The method of claim 21, wherein the gas sealed within the seal gas material is air, nitrogen (N₂), oxygen (O₂), carbon dioxide (CO₂), nitrous oxide (N₂O) or any mixture of these.
